(19) United States
(12) Patent Application Publication
(10) Pub. No.: US 2019/0056873 A1
(43) Pub. Date: Feb. 21, 2019

(54) COLD DATA STORAGE

(71) Applicant: Futurewei Technologies, Inc., Plano, TX (US)

(72) Inventors: Xiaogang ZHU, Santa Clara, CA (US); Masood MORTAZAVI, San Jose, CA (US); Fangping LIU, Santa Clara, CA (US)

(73) Assignee: Futurewei Technologies, Inc., Plano, TX (US)

(21) Appl. No.: 15/677,825

(22) Filed: Aug. 15, 2017

(51) Int. Cl. G06F 3/06; G06F 13/42; G06F 13/40

(52) U.S. Cl. CPC G06F 3/0619; G06F 3/0611; G06F 3/0635; G06F 2213/0042; G06F 13/4282; G06F 13/4022; G06F 2213/4004; G06F 3/067

(57) ABSTRACT

The disclosure includes a cold storage system. The cold storage system includes a server having a plurality of host hub ports, a first Universal Serial Bus (USB) switch and a plurality of USB storage devices. The first USB switch has a plurality of downstream (DS) ports and a plurality of upstream (US) ports and is connected to the server via a first host hub port of the plurality of host hub port and a first US port of the plurality of US ports. Furthermore, the first USB switch has a controller configured to establish a connection between the first US port and a first DS port of the plurality of DS ports in response to a command identifying the first DS port from the server. The plurality of USB storage devices are respectively connected to the first USB switch via the plurality of DS ports and a first USB storage device the plurality of USB storage devices is connected to the first DS port of the first USB switch.

### BACKGROUND

A cold storage system is a system or mode of operation designed for the retention of inactive data. Examples of data types for which cold storage may be suitable include information a business is required to keep for regulatory compliance, video, photographs, and data that is saved for backup, archival or disaster recovery purposes. High-performance primary storage is generally considered too expensive for inactive data that is retained on a long-term or indefinite basis.

### SUMMARY

According to one aspect of the present disclosure, a cold storage system is provided. The cold storage system includes a server having a plurality of host hub ports, a first Universal Serial Bus (USB) switch and a plurality of USB storage devices. The first USB switch has a plurality of downstream (DS) ports and a plurality of upstream (US) ports and is connected to the server via a first host hub port of the plurality of host hub port and a first US port of the plurality of US ports. The DS ports and the US ports are for transmitting and receiving messages based on USB standard. Furthermore, the first USB switch has a controller configured to establish a connection between the first US port and a first DS port of the plurality of DS ports in response to a command identifying the first DS port from the server. The plurality of USB storage devices are respectively connected to the first USB switch via the plurality of DS ports and a first USB storage device of the plurality of USB storage devices is connected to the first DS port of the first USB switch.

In any preceding aspect, another implementation of the aspect provides that the connection between the first US port and the first DS port includes a power line for connecting electric power from the server to a USB storage device through the USB switch.

In any preceding aspect, another implementation of the aspect provides that the system includes a power supply for providing power to the USB switch, wherein the USB switch connects the power to the first USB storage device when the connection between the first US port and the first DS port is formed.

In any preceding aspect, another implementation of the aspect provides that a number of the plurality of USB storage devices is greater than 127.

In any preceding aspect, another implementation of the aspect provides that the server has stored data identifying a route from the server to the first USB storage device via the first USB switch.

According to one aspect of the present disclosure, a server is provided. The server includes a non-transitory memory comprising instructions, a plurality of host hub ports and a processor in communications with the memory. The processor is configured to execute the instructions to send a first message based on Universal Serial Bus (USB) standard, from a first host hub port of the plurality of host hub ports to a first upstream (US) port of a plurality of US ports of a first USB switch, to establish a connection between the first US port of the first USB switch and a first downstream (DS) port of the first USB switch, wherein the first message is sent based on a first route from the server to a first USB storage device, wherein the memory includes first data identifying the route.

In any preceding aspect, another implementation of the aspect provides that the server further includes a power circuit, where the power circuit is configured to provide electric power to the first USB storage device via the first host hub port of the server and the first DS port of the first USB switch.

In any preceding aspect, another implementation of the aspect provides that the processor is configured to send a second message based on the USB standard, from the first host hub port to the first US port of the first USB switch, to connect a second DS port of the first USB switch to the first US port.

In any preceding aspect, another implementation of the aspect provides that the non-transitory memory includes second data identifying a second route from the server to a second USB storage device via a second DS port of the first USB switch.

According to one aspect of the present disclosure, a method for cold data storage system is provided. According to the method, a server sends a first message based on Universal Serial Bus (USB) standard, from a first host hub port of the server to a first upstream (US) port of a USB switch, to establish a connection between the first US port of the USB switch and a first downstream (DS) port of the USB switch, wherein the first message is sent based on a first route from the server to the USB switch. The server further accesses a first USB storage device through the connection between the first DS port and the first US port.

In any preceding aspect, another implementation of the aspect provides that the established connection forms power connection between the first US port and the first DS port.

In any preceding aspect, another implementation of the aspect provides that the server stores first data identifying the first route from the server to the first USB storage device, where the first route include the first DS port of the USB switch.

In any preceding aspect, another implementation of the aspect provides that the server sends a second message based on the USB standard, from the first host hub port to the first US port of the USB switch, to connect a second DS port of the USB switch and the first US port. The server may further store second data identifying a second route from the server to a second USB storage device, where the second route includes the second DS port of the USB switch.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of cold storage system according to an embodiment.

FIG. 2 is a block diagram of a USB switch 120 according to an embodiment.

FIG. 3 is a block diagram of a server 110 according to the embodiment.

FIG. 4 is a flowchart illustrating a method for generating a Device Connection Mapping Table according to the embodiment.

FIG. 5 is a flowchart illustrating a method for accessing a USB storage device for data in the system according to the embodiment.

### DETAILED DESCRIPTION

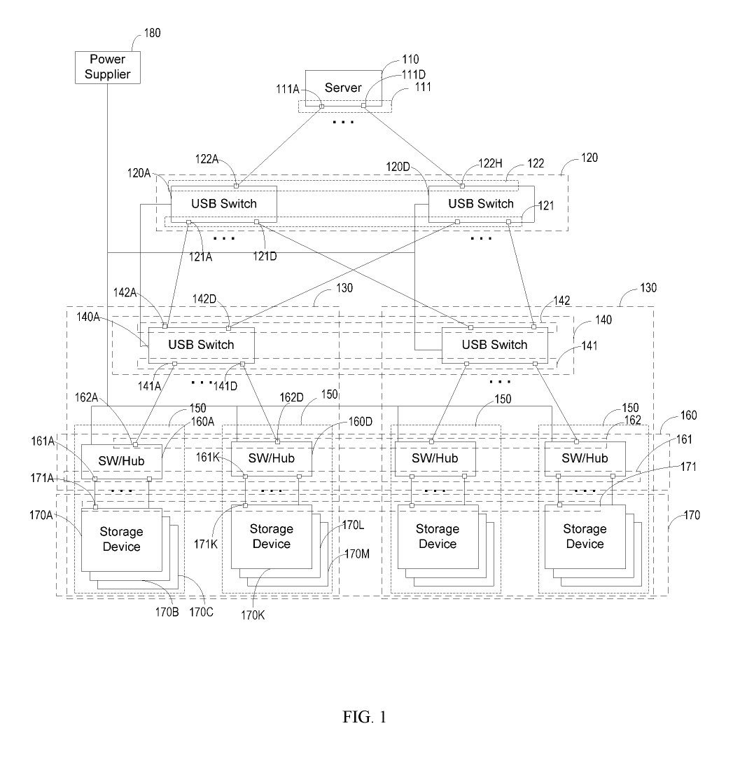

FIG. 1 is a schematic diagram of cold storage system according to an embodiment. In this embodiment a cold storage system 100 may include a server 110, a plurality of Universal Serial Bus (USB) switches 120 and a plurality of storage device chassis 130. Each storage device chassis 130 may include a USB switch 140 and a plurality of storage blades 150.

The server 110 has a plurality of host hub ports 111, such as host hub ports 111A and 111D. Each USB switch 120 has a plurality of downstream (DS) ports 121 and a plurality of upstream (US) ports 122. For example, USB switch 120A has a plurality of DS ports including DS ports 121A-121D and has a plurality of US ports including port 122A. Each USB switch 120 is physically connected to a downstream (DS) port 111 of the server 110 through an upstream (US) port 122. For example, USB switch 120A is connected to host hub port 111A through the US port 122A and USB switch 120D is connected to the host hub port 111D through the US port 122H. A single host hub port 111 may only be physically connected to a single USB switch. Furthermore, a host hub port 111 is a USB port and the data transmitted through the host hub port 111 is based on a Universal Serial Bus (USB) standard, such as USB standard 2.0 or USB 3.0.

Each storage device chassis 130 may include a USB switch 140 and a plurality of storage blades 150. Each USB switch 140 has a plurality of DS ports and a plurality of US ports. For example USB switch 140A has a plurality of DS ports including DS ports 141A-141D and has a plurality of US ports including US ports 142A-142D. In the system 100, each USB switch 140 is physically connected to a DS port 121 of a USB switch 120 through a US port 142. For example, USB switch 140A is connected to the DS port 121A through the US port 142A. A single DS port 121 may only be physically connected to a single USB switch 140.

Each storage blade 150 may include a USB connection device 160 and a plurality of storage devices 170. For example, the storage blade connected to DS port 141A includes USB connection device 160A and USB storage devices 170A-170C; the storage blade connected to DS port 141D includes USB connection device 160D and USB storage devices 170K-170M. In some embodiments, each USB connection device 160 is connected to a USB switch 140 and each USB connection device 160 is connected with a plurality of USB storage devices 170. A USB connection device 160 may be a USB hub or a USB switch. A single USB connection device 160 may be physically connected to a single DS port 141 of a USB switch 140 on the same chassis 130. For example, the USB connection device 160A may be physically connected to the DS port 141A through the US port 162A and the USB connection device 160D may be physically connected to the DS port 141D through the US port 162D. A single storage device 170 may be physically connected to a single DS port 161 of a USB connection device 160 through a USB port 171 of the single storage device 170. For example, USB storage device 170A is connected to the DS port 161A through the USB port 171A and USB storage device 170K is connected to the DS port 161K through the USB port 171K. The system 100 may further include power supplier 180, which may provide electric power to all or some of the USB switches in the system.

In some embodiments, the system 100 may include another server (not shown in FIG. 1). The other server may be a backup server of the server 110. When the server 110 fails, the backup server may work as the server 110. In some embodiments, the other server is also another primary or active server, which can access a USB storage device when the server 110 is accessing another USB storage device. In some embodiments, the other server is both the backup server of the server 110 and is another primary or active server. Each USB connection device 160 in the embodiment may be a USB switch or a USB hub. In the system 100, all USB switches 120 may be considered as in a switch layer 1 and all USB switches 140 may be considered as in a switch layer 2. All the USB connection devices 160 may be considered in a switch layer 3 when the USB connection device 160 are USB switches. In some embodiments, to support a large number of storage devices 170, such as more than 127, in a cold storage system 100, some additional layers of USB switches may be introduced. In some embodiments, the system may have fewer layers depending on the capacity requirements of the system. When the USB connection device 160A is a USB hub, it will be activated when the DS port 141A is connected to a US port 142A after the USB switch 140A successfully processes a CONNECT_PORT message. Upon the activation of the USB connection device 160A (a USB hub), all of the connected USB storage devices 170A-170C are activated. When the DS port 141A is disconnected from the US port 142A, the USB connection device 160A (a USB hub) becomes inactive. As a result, the USB hub and storage devices 170A-170C become inactive. When the USB connection device 160A is a USB switch, the USB storage device 170A is activated only when the DS port 161A is activated after the USB switch 160A successfully processes a CONNECT_PORT message. After the storage device 170A is activated, the data can be transmitted between the server 110 and the USB storage device 170A. Activating a storage device may include powering the storage device 170, such as storage device 170A, through a USB port 171, such as port 171A, of the storage device 170 so that data may be sent to the storage device 170 through the USB port 171 or data may be read from the storage device 170 to the server 110 through the USB port 171.

To access an individual one of the USB storage devices 170 within the cold storage system 100, the server establishes a connection to the individual USB storage device via USB switches in the system 100. Before establishing the connections to different USB storage devices within the system, the server 110 needs to generate a Device Connection Mapping Table. The table may be generated during system initialization time. Table 1 illustrates an example of a Device Connection Mapping Table.

TABLE 1

| | | Host | L1 | L2 | L3 | Device |
|---|---|---|---|---|---|---|
| | | Hub | DS | DS | DS | USB |
| Index | Device ID | Port | port | port | port | Address |
| 1 | “Disk 1” | 1 | 1 | 1 | 1 | |
| 2 | “Disk 2” | 1 | 1 | 1 | 2 | |
| 3 | “Disk 3” | 1 | 1 | 1 | 3 | |
| 4 | “Disk 4” | 1 | 1 | 1 | 4 | |
| 5 | “Disk 5” | 1 | 1 | 2 | 1 | |
| 6 | “Disk 6” | 1 | 1 | 2 | 2 | |
| 7 | “Disk 7” | 1 | 1 | 2 | 3 | |
| 8 | “Disk 8” | 1 | 1 | 2 | 4 | |
| 9 | “Disk 9” | 1 | 1 | 3 | 1 | |
| 10 | “Disk 10” | 1 | 1 | 3 | 2 | |
| 11 | “Disk 11” | 1 | 1 | 3 | 3 | |
| 12 | “Disk 12” | 1 | 1 | 3 | 4 | |
| 13 | “Disk 13” | 1 | 1 | 4 | 1 | |
| 14 | “Disk 14” | 1 | 1 | 4 | 2 | |
| 15 | “Disk 15” | 1 | 1 | 4 | 3 | |
| 16 | “Disk 16” | 1 | 1 | 4 | 4 | |
| 17 | “Disk 17” | 1 | 2 | 1 | 1 | |
| 18 | “Disk 18” | 1 | 2 | 1 | 2 | |
| 19 | “Disk 19” | 1 | 2 | 1 | 3 | |
| 20 | “Disk 20” | 1 | 2 | 1 | 4 | |
| . . . | . . . | . . . | . . . | . . . | . . . | |

During the system initialization, server 110 may iterate all of storage devices in the system 100, establish a connection to each storage device 170, assign a unique Device ID to the storage device 170 and create an entry in the Device Connection Mapping Table for each storage device 170. The Device Connection Mapping Table illustrated by Table 1 includes an entry for each storage device 170, where each of Disks 1-20 in the table respectively identifies a USB storage device 170 in the system 100. Each entry includes a plurality of fields, such as Device ID, host hub port, L1 DS Port, L2 DS Port, L3 DS Port, Device USB Address, etc. The Device ID for each USB storage device 170 is unique within the cold storage system 100. Host hub port in Table 1 is a port number of a USB port 111 of a host USB hub on the server 110. L1 DS Port in Table 1 is the port number of a port 121 on a USB switch 120. L2 DS Port in Table 1 is the port number of a DS port 141 on a USB switch 140. L3 DS Port in Table 1 is the port number of a DS port 161 on a USB connection device 160, where the USB connection device 160 may be a USB switch or a USB hub. Device USB Address is the USB address assigned to a storage device 170. The Device ID assigned to a USB storage device 170 is stored in the USB storage device 170 and may be retrieved back later for validation purpose. The host hub port and the DS ports of USB switches in an entry may identifies a route from the server 110 to a USB storage device 170. By configuring the DS ports of USB switches identified by the entry for a target USB storage device 170, a connection from server 110 to the target storage device 170 can be established during run-time.

In the system 100, after a connection between the server 110 and a USB storage device 170, such as the USB storage device 170A, is established, the connection may be cancelled and then be re-established. In the situation that the connection is re-established, the USB Address of the storage device 170, such as the USB storage device 170A, for the re-established connection may be different from the USB Address of the same storage device 170, such as the USB storage device 170A, for the previous connection between the server 110 and the USB storage device 170. The value of USB Address in the Device Connection Mapping Table needs to be updated each time when the connection to the USB storage device 170 is established when the USB connection device 160 is a USB hub. When the USB connection device 160 is a USB switch, the USB address in the table may not be necessary.

Based on the Device Connection Mapping Table, the server 110 may use a Device ID of a target USB storage device 170 to find an entry for the target USB storage device 170 and establish a connection to the target USB storage device 170 according to the route identified by the entry. As disclosed above, the USB connection devices 160 in the system 100 may either be USB switches or USB hubs. The establishment of the connection between the server 110 to a USB storage device 170 in the situation that the USB connection devices 160 are USB switches is different from the establishment of the connection in the situation that the USB connection devices 160 are USB hubs. The establishment of the connections in the two situations is respectively introduced hereinafter.

In the situation that the USB switches are used as USB connection devices 160 and the server wants to access a USB storage device 170A, the server 110 sends a first CONNECT_PORT message to the port 122A on the USB switch 120A to connect to connect port 121A to port 122A. After the port 121A is connected to port 122A, the link between server 110 and the USB switch 140A is established. The server 110 may send a second CONNECT_PORT message to port 142A on the USB switch 140 via the USB switch 120A to connect port 141A to 142A. After the port 141A is connected to port 142A, the link between the server 110 to the USB switch 160A is established. The server 110 may send a third CONNECT_PORT message to port the 162A on the USB switch 160A to connect the port 161A to the port 162A. After the port 161A is connected to the port 162A, the link from server 110 to the USB storage device 170A is established. The server 110 may assign a USB address to the USB storage device 170A and access data on the USB storage device 170A based on its USB address.

In the situation that the USB hubs are used as USB connection devices 160 and the server wants to access a USB storage device 170A, the server 110 sends a first CONNECT_PORT message to the port 122A on the USB switch 120A to connect to connect port 121A to port 122A. After the port 121A is connected to port 122A, the server 110 sends a second CONNECT_PORT message to port 142A on the USB switch 140 via the USB switch 120A to connect port 141A to 142A. After the port 141A is connected to port 142A, the links between server 110 and each of the USB storage devices 170 connected to the USB connection device 160A (a USB hub), such as USB storage devices 170A-170C, are established. The server may assign a USB address to each of the USB storage devices 170, such as storage devices 170A-170C, retrieve the Device ID from each of the USB storage devices 170, and update the USB Address of the storage device 170A-170C in each entry in Device Connection Mapping Table based on Device ID. Furthermore, server 110 may access data on the USB storage device 170A based on the USB Address from Device Connection Mapping Table.

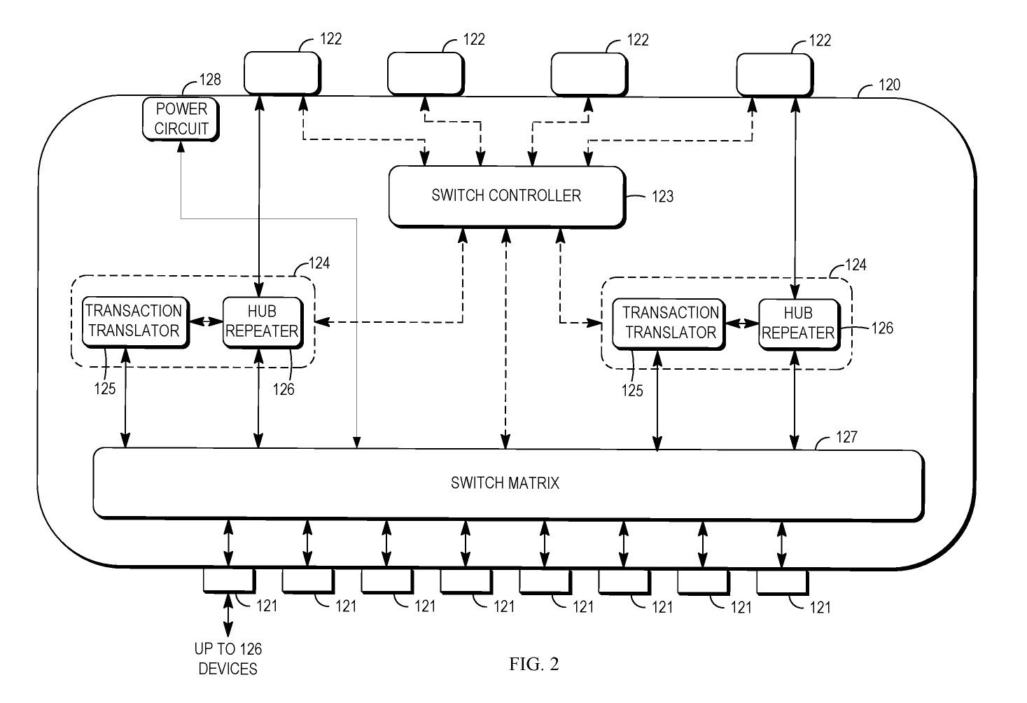

FIG. 2 is a block diagram of a USB switch 120 according to an embodiment. In the cold storage system 100, the USB switches 120 and the USB switches 140 have the same structure. When the USB connection device 160 are USB switches, USB switches 120 and USB connection device 160 also have the same structure. In the In the interest of brevity and clarity, the USB switch 120 in FIG. 2 is shown with only four US ports 122 and eight USB DS ports 121. However, one of ordinary skill in the art would realize that the switch 120 can have greater numbers of both the host ports (DS ports) 122 and the USB network ports (DS ports) 121 and still operate as disclosed herein.

The USB switch 120 includes a switch controller 123, one or more of USB interfaces 124, and a switch matrix 127. The switch controller 123 is connected to each of the host ports 122, the USB interfaces 124, the switch matrix 127 and power circuit 128. The host ports 122 are also called as upstream (US) ports. The switch controller 123 is configured to control operation of the USB switch 120. The controller 123 may be implemented as a field programmable gate array (FPGA), an application specific integrated circuit (ASIC), a dedicated central processing unit (CPU), or any other controller circuitry and may include memory to store a switch table, as described subsequently. Each of the USB interfaces 124 includes a transaction translator 125 and a hub repeater 126. The operation of the USB interfaces 124 is controlled by the switch controller 123. In the interest of clarity and brevity, only two USB interfaces 124 are shown. However, in an embodiment, there are the same number of USB interfaces 124 as host ports (DS ports) 122. Each USB interface 124 is connected to a different, respective host port (DS port) 122.

The hub repeater 126 comprises a driver circuit to provide extra current capabilities for transmission of data to and from a particular network of USB devices. The driver circuit of the hub repeater 126 also provides extra current for data received from the particular network of USB devices to be transmitted to a particular host connected to one of the host ports (US ports) 122. Operation of the hub repeater 126 is transparent to operation of the USB switch 120. The hub repeater 126 is well known in the art and discussed further in the USB standards documents. During data transmissions, data traffic received from a host port (US port) 122 is forwarded to a particular selected USB device port (DS port) 121, then broadcast to all devices connected to the USB device port (DS port) 121. Each USB device connected to the USB device port (DS port) 121 is able to select its own data traffic by the USB device address embedded in the transmission. Data received from the USB device port (DS port) 121 is forwarded to the requesting host port (US port) 122 only. The switch matrix 127 is configured as a circuit switch (it can be a crossbar) based on the mapping between USB device ports (DS ports) 121 and host ports (US ports) 122. The switch controller 123 also keeps track of the mapping and makes the requested updates. Data sent by a USB device is received by the requesting the host port (US port) 122 but not by the other host port (US port) 122.

The transaction translator 125 automatically recognizes and provides translation of data from one USB standard to another USB standard. For example, the requesting host may only have USB 2.0 drivers while one or more of the USB devices connected to the selected USB device port. The port selection is done by the request of the hosts. If a specific device port is available, it is assigned per host-request. Port 121 may support USB 3.0 operation. The transaction translator 125 translates between the lower standard (e.g., USB 2.0) and the higher standard (e.g., USB 3.0). The transaction translators 125 may be multi transaction translators (Multi-TT) that provide more transaction translators such that bottlenecks are avoided. The transaction translator function is well known in the USB art and discussed in greater detail in the USB standards documents.

The switch matrix 127 includes a plurality of selectable connecting elements (e.g., transistors) that can be selectively activated by the switch controller 123 to connect a selected USB network port (DS port) 121 to the requesting host port (US port) 122 through its respective USB interface 124.

The power circuit 128 receives electric power from a power supplier and then provides electric power to switch matrix 127. When the switch matrix 127 connects a selected USB network port (DS port) 121 to a host port (US port) 122, the switch matrix 127 provides the electric power received from the power circuit 128 to the apparatus connected to the USB network port (DS port) 121, where the apparatus may be a USB switch, a USB hub or a USB storage device.

In operation, once a host, such as a server, is connected to the switch 120, the host performs an enumeration process as a USB device. If there are multiple switches 120 that a host can connect to, the host connects to each switch 120 as if each switch 120 is a different USB device and enumerates each one.

USB enumeration is the process of detecting, identifying and loading drivers for a USB device. This involves a mixture of hardware techniques for detecting something is present (e.g., pulled up pins) and software to identify what device (e.g., USB 2.0, USB 3.0) has been connected. The enumeration assigns a different address to each detected USB device. This address is then used in the address field of packets broadcast to the USB devices so that only the device with that particular address in the address field reads the packet. The other USB devices ignore packets that do not contain their assigned address.

Once the host is connected to the USB switch 120 and enumerates the USB switch 120, the host issues a request (e.g., CONNECT_PORT) to connect to a specific port of the switch 120 or to disconnect from its current port. Connecting to a specific port can be carried out at the application level. For example, a host might refer to a centralized name server type determine which port to connect to. Alternatively, the host can scan the device ports and get to know their contents on its own. If the requested port is available, the switch 120 will send an acknowledgement (e.g., ACK) back to the host. The switch controller 123 updates a USB switch table with the host identification and the port now assigned to that particular host (e.g., requesting host). The host may then transmit data traffic to that particular port with the address of the selected device, found during enumeration, in the address field of the data packets. The enumeration of the devices behind the switch starts as soon as the switch matrix is configured to connect the host port to the related device port. Since it is a circuit switch, the host recognizes and enumerates all of these new USB devices one-by-one as if they are physically attached.

If the requested port is not available, the switch 120 transmits a bitmap representing a list of available switch ports back to the host. The host may then select a port from this list of available ports. The host transmits this selected port in another port connection request and the operation continues as outlined previously.

If the host is already operating with a selected port, the host may decide to disconnect from that port. This may be accomplished by transmitting a connection request to a predetermined port (e.g., Port 0) that tells the switch controller 123 that the port currently being used by the host can be disconnected and the USB switch table updated to remove the assigned port from that host.

The number of USB devices connectable to the USB switch 120 may be changed by either changing the number of ports on the USB switch 120, changing the number of nested levels of USB switches 120, or connecting the each host to multiple switches.

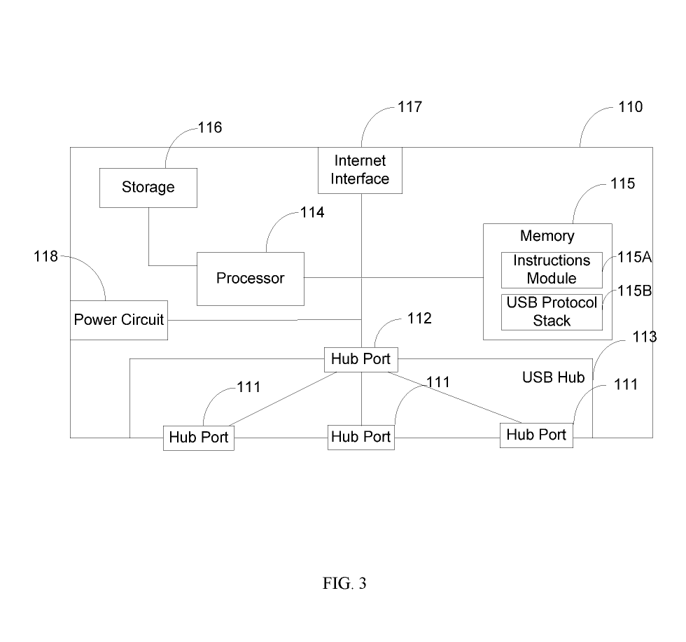

FIG. 3 is a block diagram of a server 110 according to the embodiment. Server 110 may include a plurality of downstream USB host hub ports 111 and an upstream USB host hub port 112. The USB host hub ports 111 and 112 belongs to a USB hub 113 included in the server 110. In the interest of brevity and clarity, the server of FIG. 3 is shown with only 3 downstream USB host ports 111.

The server 110 further includes a processor 114, a memory 115, a storage 116, an Internet Protocol (IP) network interface 117 and power circuit 118. Processor 114 may be implemented as a general processor or may be part of one or more application specific integrated circuits (ASICs) and/or digital signal processors (DSPs). The general processor may refer to a plurality of processors. A processor may have a single processing core or have multiple processing cores. Memory 115 may include a cache for temporarily storing content, e.g., a random-access memory (RAM). Additionally, memory 115 may include a long-term storage, e.g., a read-only memory (ROM). Memory 115 may further includes an instruction module 115A and a USB standard stack 115B, which are two software modules stored in the cache and/or the long-term storage. The instruction module 115A includes computer-readable instructions, based on which processor 114 may make the server 110 to perform, in cooperation with USB host hub ports 111, all the actions of the server in cold storage system 100. Based on the USB protocol stack 115B, server 110 may communicate with USB switches and USB storage devices through USB host hub ports 111 on the server 110 and USB ports on the USB switches and USB storage devices. Storage 116 includes a hard disk drive (HDD), a solid state drive (SSD), a flash memory, a compact disc read-only memory (CD ROM), Digital Versatile Disks (DVD) or other optical disk storage, magnetic cassettes, magnetic tape, magnetic disk storage, or other magnetic storage devices, or any other medium capable of storing data. The data stored in the storage 116 may include the instructions in memory 115 and may further include other data, such as media data and file data, received from the IP network through the IP network interface 117 and from USB storage devices through host hub ports 111. The power circuit 118 provides electronic power for the elements in the server 110, such as the processor 114, storage 116 and memory 115.

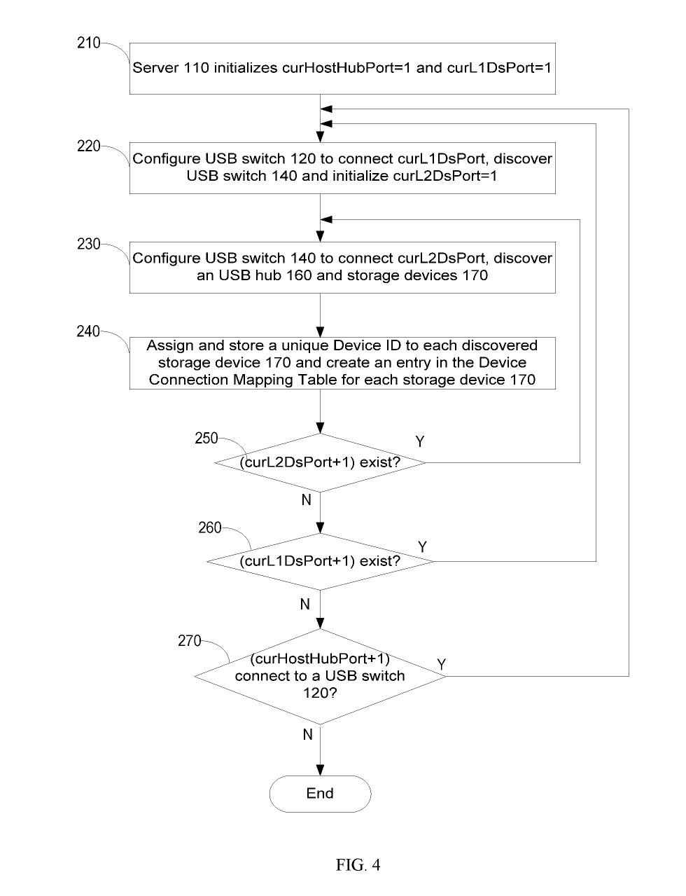

FIG. 4 is a flowchart illustrating a method for generating a Device Connection Mapping Table according to the embodiment. The method 200 is for generating a Device Connection Mapping Table similar to the Table 1 disclosed above when USB hubs are used as the USB connection device 160 in system 100. The method starts at operation 210 during system initialization period.

At operation 210, server 110 initializes the value of curHostHubPort to 1 and the value of curL1DsPort to 1 for the purpose of iterating all DS ports of USB switches 120. curHostHubPort is a viable referring to the current host hub port of server 110 and curL1DsPort is a variable referring to the current DS port of a USB switch 120, where the current DS port is the next DS port to be configured by server 110 and the current host hub port is the host hub port used to configure the next DS port.

At operation 220, server 110 configures USB switch 120 to connect a DS port 121 identified by curL1DsPort to a US port, discovers a USB switch 140 and initializes curL2DsPort to 1.

The server 110 configures a USB switch 120 according to the values of curHostHubPort and curL1DsPort. Server 110 sends a CONNECT_PORT message with the value of curL1DsPort to the connected USB switch 120 through a host hub port identified by curHostHubPort and requires to connect a DS port 121 identified by the curL1DsPort to the US port receiving the CONNECT_PORT message at the USB switch 120. After the CONNECT_PORT message is successfully processed on the USB switch 120, server 110 may further discover a USB switch 140 which is physically connected to the DS port identified by curL1DsPort. For example, when the value of curHostHubPort is 1 and the value of curL1DsPort 1, the server 110 sends a CONNECT_PORT message via port 111A to establish connection between the server 110 and the port 121A.

The CONNECT_PORT message (CONNECT_PORT request) comprises the following fields:

TABLE 2

| Offset | Field | Size | Value | Description |
|---|---|---|---|---|
| 0 | bmRequestType | 1 | Bitmap | Characteristics of Request |
| | | | | D7: Data Transfer Direction |
| | | | | D6-5: Type (00) |
| | | | | D4-0: Recipient(00011) |
| 1 | bRequest | 1 | Value | 13₁₀ = 0x0D_{H}, |
| | | | | CONNECT_PORT request |
| 2 | wValue | 2 | Value | Requested port to connect to |
| 4 | wIndex | 2 | Index or | Zero |
| | | | Offset | |
| 6 | wLength | 2 | Count | Zero |

The CONNECT_PORT request with bmRequestType 0x03 indicates that the recipient will be a USB switch and not a USB storage device, interface, or endpoint. The bRequest field of the present embodiments has a value of 13 that may be represented by the hexadecimal number 0x0D. The field wVALUE is the port number p that the host is requesting to connect with. If that port is available, the switch acknowledges with a 0-length DATA packet and an ACK packet. If the Port p is an unavailable port, the switch performs a data transfer to submit the list of available ports to the requesting host. If Port P is set to “0” (or some other predetermined port ID), the host is indicating that it wishes to disconnect from the current port. The fields wIndex and wLength are zero.

At operation 230, the server 110 configures USB switch 140 to connect a DS port 141 identified by curL2DsPort to a US port of the USB switch 140, discovers a USB hub 160 and USB storage devices 170.

The server 110 sends a CONNCT_PORT message with value of curL2DsPort to the newly discovered USB switch 140 and requires to connect the DS port 141 identified by curL2DsPort to the US port receiving the CONNCT_PORT message. After the connection from server 110 to the DS port identified by curL2DsPort is established, the USB hub 160 and all of the storage devices 170 connected to the hub are discovered. For example, when the value of curL2DsPort is 1, the CONNCT_PORT message is used to establish the connection between the server 110 and the port 141A; when the value of curL2DsPort is 4, the CONNCT_PORT message is used to establish the connection between the server 110 and the port 141D.

At operation 240, server 110 assigns and stores a unique Device ID to each discovered USB storage device 170, and creates an entry in Device Connection Mapping Table for each discovered USB storage device 170. Device ID, curHostHubPort, curL1DsPort, and curL2DsPort are recorded in the corresponding fields in each entry. Device IDs stored in USB storage devices 170 may be retrieved later to identify the USB storage devices from each other. For example, the entry of the USB storage device 170A may include the Device ID of the device 170A, port number of the port 111A, port number of the port 121A and port number of the port 141A. Because the server 110 does not need to activate the port 161A, the entry does not need to include the port number of the port 161.

At operation 250, server 110 checks whether the USB switch 140 has a DS port 141 next to the DS port identified by curL2DsPort. If it exists, server 110 increments the value of curL2DsPort by 1 at operation 251 and then proceeds to operation 230. For example, when the value of curL2DsPort increments to 2, the server 110 is going to establish a connection from the server 110 to port 141B (not shown in FIG. 1), the port next to port 141A. If it does not exist, method 200 proceeds to operation 260.

At operation 260, server 110 checks whether the L1 USB switch 120 has a L1 Switch DS port 121 next to the DS port identified by curL1DsPort. If it exists, server 110 increments the value of curL1DsPort by 1 at operation 261 and then proceeds to operation 220. If it does not exist, method 200 proceeds to operation 270.

At operation 270, server 110 checks whether the server 110 has a USB host hub port 111 next to the port identified by curHostHubPort. If it exists, server 110 increments curHostHubPort by 1, resets curL1DsPort to 1 at operation 271 and then proceeds to operation 220; if it does not exist, method 200 ends.

By iterating host hub port 111, DS ports 121, and DS ports 141, server 110 walks through all of USB storage devices 170 in the system 100, assigns and saves a unique Device ID to each for them, and generates the entries in Device Connection Mapping Table. The procedure may be implemented by recursive function call, which may be even more efficient and flexible when more layers of USB switches are required for a cold storage system 100.

When USB switches are used as the USB connection devices 160, each DS port 161 of the USB connection device 160 can only be connected to one USB storage device 170. In this case, the DS port 161 may uniquely identify a USB storage device 170. Device Connection Mapping Table may be easily generated by assigning a Device ID to each USB storage device 170 and creating an entry in the table with a host hub port number, a DS port number of a DS port of a USB switch 120, a DS port number of a DS port of a USB switch 140 and a DS port number of a DS port of a USB switch 160. The Device Connection Mapping Table can be generated without walking through all of storage devices 170 during the system initialization.

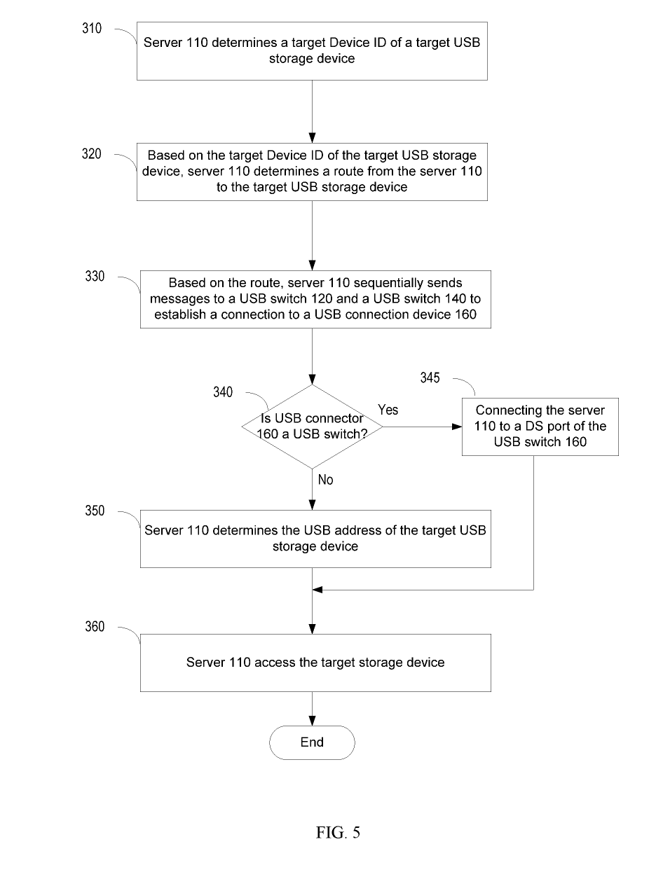

FIG. 5 is a flowchart illustrating a method for accessing a USB storage device in the system for data transmission according to the embodiment. At operation 310, the server 110 determines a target Device ID of a target USB storage device to access, such as the USB storage device 170A. Accessing a USB storage device 170 may be a read operation reading data from a USB storage device 170 or a write operation writing data to a USB storage device 170. When receiving a file write request from a remote client, server 110 will assign a Device ID of a target USB storage device 170 for the file. When receiving a file reading request from a remote client, server 110 will obtain the Device ID of the target USB storage device 170 from the file system based on the file name.

At operation 320, based on the target Device ID, server 110 determines a route from the server 110 to the target USB storage device.

The server 110 may determine the entry of the target USB storage device in Device Connection Mapping Table based on the target Device ID, where the entry includes the route from server 110 to the target USB storage device 170. The route may include DS port numbers of USB switches along the route. The route in the entry of the target USB storage device may include an L1 DS port number, which is a port number of a DS port 121 on a USB switch 120, an L2 DS port number, which is a port number of a DS port 141 on a USB switch 140 as shown in FIG. 1. Furthermore, the route may include a port number of a USB host hub port 111 on server 110. The route may further include an L3 DS port number, which is a port number of a DS port 161 of a USB connection device 160 when the USB connection device is a USB switch. In an example, when the target USB storage device is the USB storage device 170A, the route include port numbers of the port 111A, the port 121A and the port 141A. When the USB connection device 160A is a USB switch, the route further include port number of the port 161A.

At operation 330, based on the route from server 110 to the target USB storage device, server 110 sequentially sends messages to a USB switch 120 and a USB switch 140 to establish a connection from server 110 to a USB connection device 160, where the USB connection device 160 is on the route from server 110 to target USB storage device.

In the example that the target USB storage device is USB storage device 170A, server 110 may send a CONNECT_PORT message including the port number to the port 121A to the USB switch 120A to connect the DS port 121A to the US port receiving the CONNECT_PORT message, i.e., port 122A. After the DS port 121A is connected to the US port 122A, the connection from the server 110 to the DS port 121A is established and the USB switch 140A, which is physically connected to the DS port 121A, will be activated and discovered by server 110. A USB address is assigned to the USB switch 140 during USB protocol handshake between the server 110 and the USB switch 140A. Then, server 110 sends a CONNECT_PORT message including the port number of the port 141A to the USB switch 140A to connect the DS port 141A and the US port receiving the message, i.e. port 142A. After the DS port 141A is connected to the US port 142A, the connection from the server 110 to the DS port 141A is established and the USB connection device 160A, which is physically connected to the DS port 141A, will be activated and discovered. A USB address is assigned to the USB connection device 160 during USB protocol handshake between server 110 and the USB connection device 160.

At operation 340, server 110 determines whether the USB connection device 160 is a USB switch. If the USB connection device 160 is a USB switch, method 300 proceeds to operation 345. If the USB connection device 160 is not a USB switch, it must be a USB hub in the embodiment and method 300 proceeds to operation 350. If the USB connection device 160 is a USB hub, all the USB storage devices 170 connected to the USB hub are already connected to the server 110. For example, if the USB connection device 160A is a USB hub, the USB storage devices 170A-C are all connected to the server 110.

At operation 345, server 110 configures USB switch 160 to connect a DS port 161 on the USB switch 160 to a US port 162 on the USB switch 160. In an example that the USB storage device 170A is the target USB storage device, server 110 sends a CONNECT_PORT message to the USB switch 160A to connect the DS port 161A to the US port receiving the message at the USB connection device 160, i.e. the US port 162A. After the DS port 161A is connected to the US port 162A, the connection from the server 110 to the USB storage device 170A is established and the target USB storage device 170A will be discovered and activated. During the handshake between server 110 and the target USB storage device 170A, server 110 assigns a USB address to the target USB storage device 170A. Then the assigned USB address is the USB address of the target USB storage device 170A. After operation 340, method 300 proceeds to operation 360.

At operation 350, the server 110 determines the USB address of the target USB storage device where the USB connection device 160 is a USB switch. In the example that the target USB storage device is the USB storage device 170A, the server 110 assigns a USB address to each of the USB storage devices 170A-170C. By retrieving the Device ID of each of the USB storage devices 170A-170C, the server 110 may find an entry for each Device ID in Device Connection Mapping Table and update the value of USB address. For example, the server 110 may select one of the three assigned USB addresses and retrieve a Device ID of a USB storage device based on the selected address. After the Device ID is retrieved, the server 110 may determine that the selected USB address is assigned to the USB storage device identified by the retrieved Device ID. Base on this method, the server 110 may determine the assignee of any assigned USB address. With the USB address of the target USB storage device 170A, the server 110 may send an access request including the USB address of the target USB storage device 170A to the USB connection device 160A (USB hub) and the request will be copied to each of the USB storage devices 170A-170C and only the target USB storage device 170A will properly acts in response to the request. USB storage devices 170B and 170C will discard the request. For example, after discover and assign an USB address to each USB storage device connected to USB connection device (USB hub) 160A, server 110 use one USB address at a time to retrieve the Device ID previously stored on the storage device during system initialization time until the Device ID assigned for the USB storage device 170A is retrieved. Then, server 110 may find the USB address of the USB storage device 170A based on the Device ID assigned for the USB storage device 170A.

At operation 360, the server 110 access the target USB storage device. Accessing the target USB storage device may refer to writing data to the target USB storage device 170 and/or reading data from the target USB storage device 170. In the example that the target USB storage device is the USB storage device 170A, the content of writing data and the content of reading data are introduced respectively. When the server 110 needs to write data to the target USB storage device 170A, the file system on server 110 determines the memory blocks on the target USB storage device 170A for the data to be written. The server 110 may write data to the determined memory blocks on the target USB storage device 170A along the connection between the server 110 and the target USB storage device 170A via the file system based on the USB address of the target USB storage device 170A. In particular, the server 110 may send packets including the data to the target USB storage device 170A, where the destination USB address of the packets is the USB address of the target USB storage device 170A. After the data is stored in the target USB storage device 170A, the file system on server 110 may create an index for the data with a file name for the data, Device ID of the target USB storage device 170A, memory blocks on the target USB storage device, and offset for the offset, etc. Based on the index, server 110 may determine the location information of the data, where the location information includes memory blocks on the target USB storage device, and offset for the offset, etc. When the server 110 needs to read data from the target USB storage device 170, the file system on server 110 may determine the location information based on the index for the data and then read data based on the location information.

After the data is stored in the target USB storage device 170A, the file system on server 110 may create an entry using the file name of the data as index, with its corresponding location information. A location information may include Device ID of the target USB storage device 170A, number of memory blocks for the data, the offset of the first memory block, etc. When retrieving data from the target USB storage device 170A, server 110 may find the location information from the file system by using file name as index, find an entry in Device Connection Mapping Table based on Device ID, establish the link to the USB storage device 170A according to the route to the storage device 170A, and then retrieve the data from the target USB storage device 170A.

After the server 110 finishes the access to the target storage device, the server 110 may withdraw the USB address assigned to the target storage device. Furthermore, the server 110 may withdraw the USB addresses assigned to the USB switches on the route between the target storage device and the server 110. The server 110 may further access a new target storage device by perform the above method 300 to the new target storage device.

As shown in FIG. 1, all of USB storage devices may not have their own power supply. Full 500 mA of bus power may be provided through a USB cable from the connected USB device, such as one or more USB switches. Because server is normally accessing data on one USB storage device 170 at a time, most USB storage devices in the system are disconnected by at their closest USB switches and do not consume any electric power. Although the USB switches, such as USB switches 120 and 140, consume some electric power, the total electric consumption by system 100 is little and the system 100 is power efficient. When server 110 accesses data on a specific USB storage device 170, only a limited number of USB devices are powered up during the time when the link from server 110 to the USB storage device 170 is established. The following example is in the situation that server 110 receives a request to access data on the USB storage device 170K. In this example, if USB switches are used as USB connection devices 160, only the USB storage 170K is powered up through the USB cable connected to the DS port 161K of USB switch 160K. No other USB storage devices 170 are powered up. If USB hubs are used as USB connection devices 160, the USB hub 160K and all of its connected USB storage devices 170K-170M are powered up through the USB cable connected to port 141D on USB switch 140A, while all of other USB hubs and USB storage devices connected to different L2 DS port 141 are not powered up.

It should be understood at the outset that, although an illustrative implementation of one or more embodiments are provided above, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In addition, techniques, systems, subsystems, and methods described and illustrated in the various embodiments as discrete or separate may be combined or integrated with other systems, modules, techniques, or methods without departing from the scope of the present disclosure. Other mappings shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A cold storage system comprising: a server having a plurality of host hub ports; a first Universal Serial Bus (USB) switch; and a plurality of USB storage devices,
wherein the first USB switch has a plurality of downstream (DS) ports and a plurality of upstream (US) ports, wherein the first USB switch is connected to the server via a first host hub port of the plurality of host hub port and a first US port of the plurality of US ports, wherein the DS ports and the US ports are for transmitting and receiving messages based on USB standard, wherein the first USB switch has a controller configured to establish a connection between the first US port and a first DS port of the plurality of DS ports in response to a command identifying the first DS port from the server, and
wherein the plurality of USB storage devices are respectively connected to the first USB switch via the plurality of DS ports, wherein a first USB storage device of the plurality of USB storage devices is connected to the first DS port of the first USB switch.

2. The system of claim 1, wherein the connection between the first US port and the first DS port includes a power line for connecting electric power from the server to a USB storage device through the USB switch.

3. The system of claim 1, the system includes a power supply for providing power to the USB switch, wherein the USB switch connects the power to the first USB storage device when the connection between the first US port and the first DS port is formed.

4. The system of claim 1, wherein a number of the plurality of USB storage devices is greater than 127.

5. The system of claim 1, wherein the server has stored data identifying a route from the server to the first USB storage device via the first USB switch.

6. A server, comprising:
a non-transitory memory comprising instructions;
a plurality of host hub ports; and
a processor in communications with the memory, wherein the processor is configured to execute the instructions to:
send a first message based on Universal Serial Bus (USB) standard, from a first host hub port of the plurality of host hub ports to a first upstream (US) port of a plurality of US ports of a first USB switch, to establish a connection between the first US port of the first USB switch and a first downstream (DS) port of the first USB switch, wherein the first message is sent based on a first route from the server to a first USB storage device, wherein the memory includes first data identifying the route.

7. The server of claim 6, wherein the server further compromises a power circuit, wherein the power circuit is configured to:
provide electric power to the first USB storage device via the first host hub port of the server and the first DS port of the first USB switch.

8. The server of claim 6, wherein the processor is configured to:
send a second message based on the USB standard, from the first host hub port to the first US port of the first USB switch, to connect a second DS port of the first USB switch to the first US port.

9. The server of claim 6, wherein the non-transitory memory includes second data identifying a second route from the server to a second USB storage device via a second DS port of the first USB switch.

10. A method performed by a server in a cold data storage system for accessing data, comprising:
sending a first message based on a Universal Serial Bus (USB) standard, from a first host hub port of the server to a first upstream (US) port of a USB switch, to establish a connection between the first US port of the USB switch and a first downstream (DS) port of the USB switch, wherein the first message is sent based on a first route from the server to the USB switch; and
accessing a first USB storage device through the connection between the first DS port and the first US port.

11. The method of claim 10, further comprising:
providing electric power to the first USB storage device via the first host hub port of the server and the first DS port.

12. The method of claim 10, further comprising:
sending a second message based on the USB standard, from the first host hub port to the first US port of the USB switch, to connect a second DS port of the USB switch and the first US port.

13. The method of claim 10, further comprising:
storing first data identifying the first route from the server to the first USB storage device, wherein the first route includes the first DS port of the USB switch.

14. The method of claim 12, further comprising:
storing second data identifying a second route from the server to a second USB storage device, wherein the second route includes the second DS port of the USB switch.
